(19) United States
(12) Patent Application Publication
(10) Pub. No.: US 2018/0315260 A1
(43) Pub. Date: Nov. 1, 2018

(54) AUTOMOTIVE DIAGNOSTICS USING SUPERVISED LEARNING MODELS

(71) Applicant: PiMios, LLC, Cranberry Township, PA (US)

(72) Inventor: Nicholas Anthony, Cranberry Township, PA (US)

(21) Appl. No.: 15/966,553

(22) Filed: Apr. 30, 2018

Related U.S. Application Data
(60) Provisional application No. 62/492,504, filed on May 1, 2017.

(51) Int. Cl. G07C 5/08; G07C 5/00; G06F 15/18; G06N 5/02

(52) U.S. Cl. CPC G07C 5/0808; G07C 5/0841; G07C 5/0816; G06N 3/02; G06F 15/18; G06N 5/022; G07C 5/008

(57) ABSTRACT

The systems and methods described herein use sensor-enabled services to provide advantages to a consumer (or other vehicle operator), a mechanic, and even vehicle manufacturers. The approach eliminates reliance on static sensors that are hardwired to Onboard Diagnostic (OBD) systems. It also reduces the need to rely on the extent of a mechanic's personal knowledge, and may be especially helpful in managing driverless vehicle fleets.

### BACKGROUND

Onboard computer systems have been an important component of passenger vehicles now for more than 40 years. Initially motivated by the need to manage fuel injection systems, proprietary interfaces and protocols eventually provided more broadly functioning engine control and diagnostics. These early systems performed functions such as flashing a check engine light or other malfunction indicator lamps on the vehicle dashboard.

In the late 1980s, the U.S. Society of Automotive Engineers (SAE) began to develop standardized diagnostics that eventually became known as the On Board Diagnostics (OBD I) specification approved in 1991. An OBD II specification became mandatory for all cars manufactured in the United States in 1996. Parallel developments in the European Union soon made OBD mandatory for vehicles sold there as well.

The amount of diagnostic information available via OBD has increased gradually over the years, with modern implementations providing real-time data in addition to a standardized diagnostic trouble codes (DTCs). The codes allow a skilled person to easily identify and potentially remedy many malfunctions, as well as control certain functions of the vehicle.

OBD systems are not without their shortcomings. A consumer can become quite confused by the number of different things that may go wrong with a present day automobile, with its hundreds of electronic subsystems. A consumer who does not have access to an OBD reader or specialized instrumentation cannot interpret DTC codes. Most all consumers rely upon the honesty and extent of personal knowledge of a mechanic to correctly diagnose and assess a needed repair action. In addition, the owners of fleet vehicles are continuously looking for ways to provide more efficient, more complete, and more cost-effective operation of their vehicles.

### SUMMARY

The systems and methods described herein use sensor-enabled services to provide advantages to consumer (or the other vehicle operator), the mechanic, and even the vehicle manufacturer. The approach eliminates reliance on static sensors that are hardwired to Onboard Diagnostic (OBD) systems. They also significantly reduce the need to rely on the extent of a mechanic's personal knowledge.

The technology also allows the same sensor set to adapt to support new feature sets via software upgrades. In particular, audio, vibration and other sensors are utilized with available filter and digital signal processing as inputs to a machine learning model. Subsets of the sensors, filters, signal processing and neural networks diagnose vehicle faults or other developing problems by building unique machine learning models for each vehicle. Because the approach can adapt, it can provide improvements in the quality of diagnostics over time. Artificial Neural Networks (ANN) can be developed in ways that result in self-learning models called Machine Learning (ML) models. This application will use machine learning model and ML model interchangeably.

The platform may also assist with the transition to driverless vehicles where the responsibility for maintenance and repair may not be with a single primary consumer.

In one of several possible implementations, an automotive diagnostics system may include two types of interfaces and a processor. A first interface connects to an on-board vehicle diagnostic system, such as an OBD-II interface. A second interface receives outputs from other types of auxiliary sensors, which may be dedicated sensor such as audio or vibration sensors, or sensors within an operator's smartphone. The processor uses this information to develop a learning model, which is preferably as supervised learning model, to map both the on-board vehicle diagnostic system outputs and auxiliary sensor outputs to an automotive fault condition.

The data received from the OBD-II or other sensors may be used to train the model or as other inputs to the model.

The processing may be located entirely within the smartphone, or in a remote cloud, or distributed between the smartphone and other remote processors.

The supervised learning model can be directed to the specific vehicle, or may be a learning model relevant to a class of vehicles, such as a vehicle make, model and year of manufacture.

The model and/or collected data may be forwarded as crowd-soured data to a vehicle manufacturer, vehicle dealer, or repair facility.

The model may further develop predictive analytics for early diagnosis of an upcoming repair with (a) a budget estimate and (b) a time by which the detected automotive fault condition is to be repaired.

### BRIEF DESCRIPTION OF THE DRAWINGS

The description below refers to the accompanying drawings, of which:

FIG. 1 shows how a machine learning model is fed from sensors and signal processing.

FIG. 2 illustrates an example of how a neural network within the machine learning model operates.

FIG. 3 illustrates an example listening device using a smartphone.

FIG. 4 shows other implementations of the listening device.

FIG. 5 shows still further implementations of the listening device using OEM-installed sensors.

FIG. 6 shows the software application.

FIG. 7 also shows the software application and its functions.

FIG. 8-1 illustrates how known diagnostics are determined.

FIG. 8-2 illustrates how unknown diagnostics are determined.

FIG. 9 illustrates examples of diagnostic information.

### DETAILED DESCRIPTION OF PREFERRED EMBODIMENTS

The novel system and its features will now be described in connection with some example embodiments.

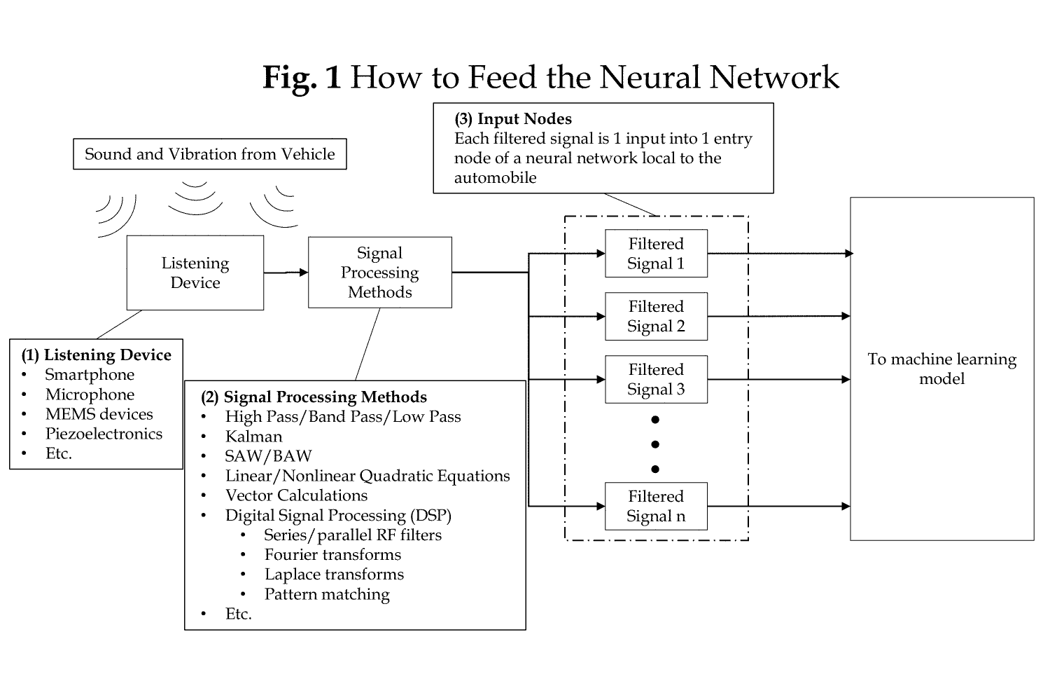

FIG. 1 illustrates how sensors (1) feed signal processing elements (2) which in turn drive decisions by a machine learning (ML) model (3). One or more sensors (1), also called “listening devices” herein, may include audio, vibration, electromagnetic, or other sensors such as microphones, accelerometers, gyroscopes, magnetometers, vibration detectors, piezoelectronics, Micro Electrical Mechanical Systems (MEMS) devices, Inertial Measurement Units (IMU) etc., located on or near a vehicle. The sensors can be specialized sensors integrated with the vehicle at the time of manufacture, specialized sensors installed as aftermarket components by a dealer or the consumer, or may be provided by the operators personal mobile device such as a smartphone or tablet which is located in the vehicle. The sensors record audio, vibrations, disturbances in electromagnetic fields, and the like that are indicative of one or more conditions of the vehicle.

Signal processing (2) is then applied to the sensor outputs. The signal processing may include, but is not necessarily limited to, some combination of filtering, such as high pass, band pass, low pass, Kalman filters, or matched filters. Depending upon the condition or symptom being detected, the filters may be applied at Radio Frequencies (RF), Intermediate Frequencies (IF) or baseband. Signal processing algorithms such as Fourier or Laplace transforms, pattern matching, quadratic equation, vector calculations and the like may also be used. The signal processing may be implemented with Digital Signal Processing (DSP) devices, or with software programmable processors, or with analog devices such as Surface Acoustic Wave (SAW) or Bulk Audio Wave (BAW) devices that may supplant or augment the DSP devices. Regardless of implementation, the filters/signal processing (2) attempts to extract one or more features of interest out of the signals generated by the sensors. However, it is not required to extract clear features from this pre-processing method before it enters the ML model.

The filter/signal processing techniques are tailored to the specific attribute condition, symptom, or whatever it is that the system is trying to detect. A combination of filtering and signal processing methods will typically be unique for the symptom to be identified, selected during a system design phase. In one example, a matched filter may be designed to detect the pinging sound of a misfiring engine. So if the symptom to be detected is an engine pinging sound that is representative of a misfiring engine problem, the designer may sample engine pinging sounds across a large number of vehicles (say 1000 vehicles), which have the engine misfire problem. The system designer then identifies the best combination of filtering or other signal processing methods to uniquely identify points of interest in the pinging sound signals. A symptom such as an engine misfire might not only be causing the pinging sound, but also a vibration anomaly, and the design might integrate detection of both sound and vibration into the signal processing (2). Detection of sound and vibration would use different respective filters or different signal processing techniques to detect one or the other. Such filters may be cascaded or may provide individual inputs to the ML model (3).

It should also be noted that the combination of filters and signal processing methods may or may not be different from one make and model of vehicle to another make and model with the same symptom(s) and same problem. However, the training of the ML model typically may vary between vehicles of the same make/model/year as well as different vehicles from different manufacturers.

So from each of the filter/signal processing outputs (and again it may be one output or one filter feeding into another filter/signal processor and that filter has an output, or an array of filters/signal processors), but outputs of the array of signal processors are then input into the ML model (3). (Again, with the understanding that the configuration of outputs to the ML model may be dynamic depending on the make and model of the car, the symptom, and the problem).

Thus any number, from one to N inputs may be provided to the ML model.

It should be understood that some or all of the sensors, filtering/signal processing methods, and machine learning model may be implemented in special purpose hardware, in a mobile phone, or in a remote server connected to the other system components or to a compute cloud. Exactly how much of which function is implemented a smart phone, how much in special purpose hardware, or how much is in the cloud, or in other places will depend upon the desired implementation as more fully explained below.

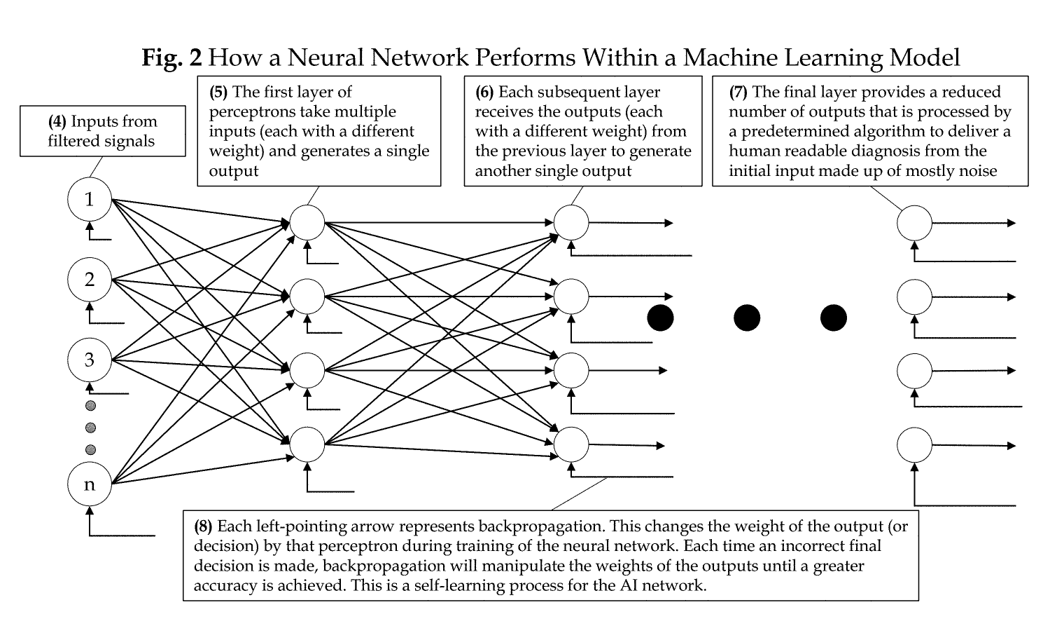

FIG. 2 illustrates a neural network within a machine learning model in more detail. In one implementation, deep learning and other high level decision making techniques may determine how the machine learning model detect trends or patterns in the data provided by the signal processing.

One example of many known instances of a machine learning model using a neural network will now be described, but it should be understood that many others are possible. As shown in FIG. 1, the input signals to a neural network are the outputs of signal processors or methods, and again there can be anywhere from 1 input signal to N of them fed into a series of nodes. The input nodes are coupled to one or more sequential layers of perceptrons. Such perceptrons may execute a process to generate an output by weighing one or more inputs. The output(s) may be a binary value or in a range, such as from zero to one. In one example, the perceptrons may use weighted feedback. However, any neural network approach or structure would also apply.

At some point, the neural network of a machine learning model needs to be trained, such as by introducing the same error into a control group of 1000 test vehicles. In this way, the output of the machine learning model can recognize a specific problem.

One preferred method of training is supervised learning. In one approach, a companion OBD-II reader is plugged into the car (or otherwise accessed) to read diagnostic codes in real time while a nearby device (phone or special hardware) is also collecting sensor data. The ML model makes determinations about the diagnosis of the vehicle (healthy or specific error). That determination will be compared to the OBD-II readout (or smartphone or other device sensors) to provide feedback to the machine learning process. This will either reinforce the ML model if the diagnosis was correct, or tell the ML model it was incorrect and re-classify it appropriately.

This training method can be done at least partially manually with human oversight (using something like Amazon's “Mechanical Turk”) or the learning process can be automated. This is one example of supervised learning. Any other method of supervised learning can apply by replacing the OBD-II reader with some other form of system or process that provides oversight to the machine learning model.

In one example, the first time a symptom is introduced into the machine learning model, it is not likely going to identify the problem. Se we need to manipulate the feedback provided by the back propagation arrows to iteratively adjust the weight of each perceptron (supervised machine learning model). This continues until the desired result is seen, with further refinement over time to obtain a baseline.

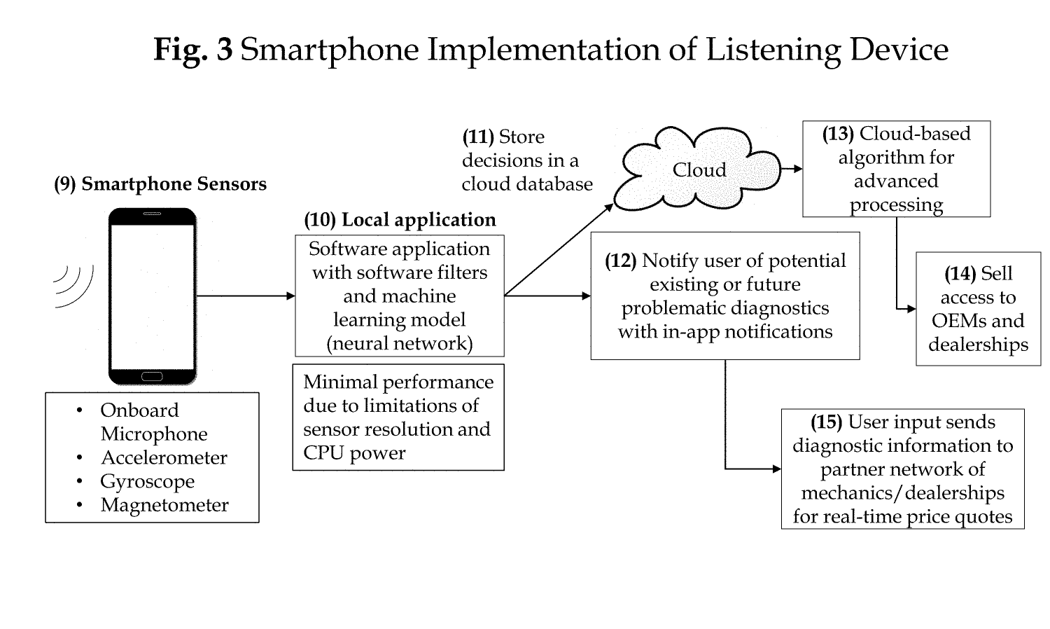

FIG. 3 illustrates various implementations of the sensor. A first implementation would be an entry level product, such as a software app running on a smartphone. This implementation uses the onboard microphone, accelerometer, gyroscope, magnetometer etc. on the smartphone as an audio sensor/or vibration monitoring, or other sensor device. This approach would be relatively crude, because the resolution on a smart phone located anywhere in the car will likely not be as accurate as purpose-designed sensors located in an engine compartment, on the under carriage near the transmission, or on an axle near the wheels or brakes, etc.

In this approach, the smart phone may be running a local application (10) that will include the machine learning model built into it, operating on outputs provided by signal processing methods that also run in the app.

In some arrangements, this simple first implementation may not even need a machine learning model. This might be possible if statistically a symptom can be adequately detected directly from the outputs of the signal processing method(s).

Here the app on the phone may make some decision(s), and these decisions may be pushed out to a cloud at (11) or further processed at (13) using back-end software hosted in the cloud or other remote server. The user may then be notified (12) of the diagnostic result through the app, or some other user experience, such as the vehicle's onboard entertainment system (infotainment system), or an email, etc.

The diagnostic information may also be sent to a partner network of dealerships or repair facilities at (15). These partners may provide real-time price quoting for a needed repair, so that the user can have a list of options to compare. In some implementations, an e-commerce back end may become involved with offering this information for access at a price (14).

For example, access on some monthly or annual basis can be provided to mechanics or manufacturers who would want access to this database of diagnostic information collected by smart phone apps running on multiple vehicles that have a diagnosed fault.

As mentioned previously, diagnostics may be stored in a cloud database at (11). The database may tie some information to each event. An event, for example, may be an engine misfire. The database will record which vehicle it came from, or which smart phone it came from, or some identifying information for the origin of the data.

The information maintained in the cloud database (11), when provided to a network of mechanics, might be specific to the one vehicle and one customer. However, the database may also be made available to OEMs, dealerships, or manufacturers that are interested in aggregate data across thousands of vehicles.

In some implementations, the smartphone application might have the entire ML model installed on it, or the ML model might be split into what the smartphone can handle and a cloud server that might be higher performance, depending upon how complex the ML models are. This feature is represented at (13), which may be one or more cloud based algorithms for advanced processing. How much information is provided to the cloud in real time or maintained over time in the database, may depend on several factors. For example, the outputs of the signal processing methods may be initially sent to the cloud at (11) for decisions at (13). Thus, the outputs of the signal processing methods may initially require a lot of data transfer at the beginning of development, while the advanced processing and machine learning model is trained. Eventually, however, the advanced processing might get particularly smart about diagnosing a certain problem. Again, using the example of an engine misfire, the system might develop a particularly clever ML model for an engine misfire on a 2012 Toyota Tacoma. Once that particularly clever ML model is identified, it might be downloaded to the software app on the smartphone for a user that owns a 2012 Toyota Tacoma. By downloading components of the ML model specific only to the vehicle, the result is to offload the workload from the cloud, and having only the pieces of the ML model that are relevant running in the smartphone.

In another scenario, the app may identify a potential issue, but not be able to conclude that there actually is a problem requiring repair or service. Since the ML model is uncertain that there is an issue, it could still notify the user to, when it's safe, stop the vehicle and put the phone closer to the potential source of the problem or engage a mechanic to diagnose the problem. In one example, the network might identify an engine ping issue and the user is prompted to safely stop the car, open the hood, and place the smartphone nearer to the engine so that higher resolution sound data can be collected.

This may also assist in situations where the problem might not be an engine misfire. The motor might have run dry of oil, and the user will blow the engine if they don't stop. Thus, there might be some additional investigation of a future or further problematic diagnostic, for which the system is not initially quite able to make a decision about just from the listening inside the passenger cabin.

Because the smart phone might be located anywhere inside the vehicle (maybe it's sitting on the passenger seat,) the smartphone may detect some fragment of something that maybe matches something that has been measured before, but the confidence level in the match isn't high. In that instance, the system can also notify the user to take some action enabling collection of some higher resolution data or engage a mechanic to diagnose the problem.

There may be something else in (12), and that's the potential for recognizing symptoms of future problems. Thus sensors (9) might be able to detect a problem that is just starting to occur, and the app might respond by making a report or suggesting actions of an early problem detection/one that may not need immediate attention, but one that should be monitored. Thus, the system can report different levels of problems. At one level, it may report that the motor is in immediate danger of failing; but in other instances it can also determine a future maintenance need, such as an oil change is needed based on the sensed data.

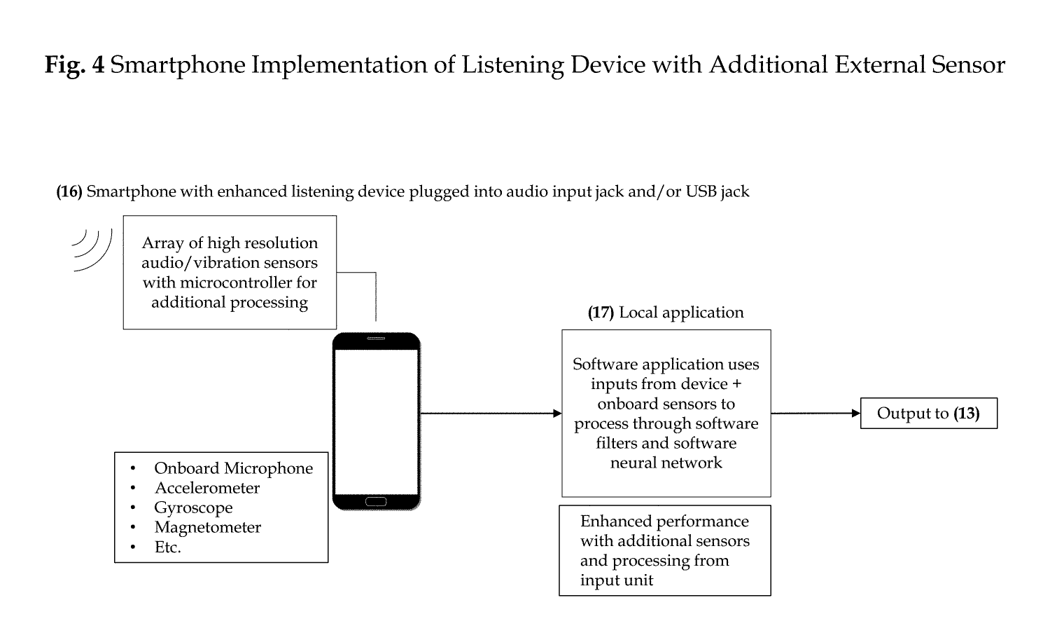

FIG. 4 illustrates another implementation of the listening device (16). In addition to the smartphone, there is an auxiliary device that connects to the smartphone in some way, either by a wired connection (such as by plugging into the headphone jack or the USB port or some other physical wired port of the smartphone), or in other implementations, the auxiliary device may connect to the smartphone via Bluetooth™ Low Energy (BLE), IEEE 802.11, Zigbee, LoRA, 915 MHz, an automotive-specific radio frequency protocol, or other wireless interface capable of data transmission.

This auxiliary device can add purpose-built sensors that provide higher resolution, or different measurements as inputs, to the system. In one example, the auxiliary device is made up of a microphone, accelerometer, gyroscope, and other sensors in an array. These higher resolution sensors may be augmented by a micro controller, Field Programmable Gate Array (FPGA), Application Specific Integrated Circuit (ASIC), or some onboard intelligence that performs pre-processing (such as filtering) and then feeds its outputs into the system. Any device or sensor placed around the vehicle will likely have its own processing capability for distributed, or de-centralized, computing.

The auxiliary device may be physically connected to and thus local to the smartphone. In other implementations, the auxiliary device is paired over a wireless connection from a more remote location (such as under the hood or adjacent a wheel axle) where an additional level of accuracy can be obtained in the diagnostics.

As before, the smart phone (16) is the central sensor collection device, so there will be a local application running there, although the inputs to that application may now come from the auxiliary device, or from the auxiliary device plus the built-in sensors of the smart phone, or some combination of the two.

And then, just as before, the filters/signal processor outputs will be ultimately run and outputs fed to the machine learning model.

It is possible that an additional ML model in the smartphone application is dedicated to supporting the sensors in the auxiliary device, or the smart phone can do nothing with those auxiliary sensor inputs and just forward them to the cloud for processing.

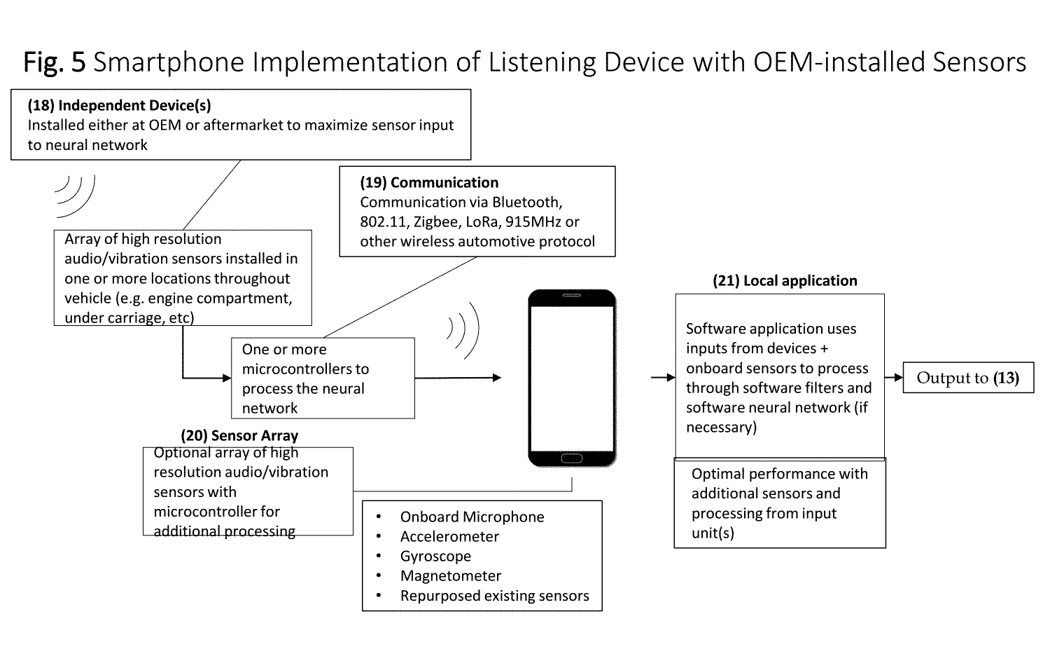

FIG. 5 shows additional implementations of the sensor device. Here there is full integration at the manufacturer level, with a high resolution array of sensors being installed as one or more sub-assemblies at the factory. With this approach, sensors/filtering/signal processing/neural network/machine learning features are preinstalled when the user buys the car, and they have the option to either pair to the system with their own smart phone, or they might access the device through user interface(s) (touchscreens, etc.) integrated into the onboard driver infotainment system.

As with the prior implementations, a high resolution array of dedicated sensors (18) and one or more micro controllers (19) feed the signal processing and then the machine learning model. Sensors are installed somewhere in the vehicle, such as in the engine compartment, in the undercarriage, adjacent an axle, an exhaust, or near other components that may fail. It is also possible to repurpose existing sensors in the vehicle, or use parts of the car to harvest acoustics, similar to Continental's “Ac2ated Sound” technology which turns a vehicle's interior into an audio speaker (20).

As with the other implementations, during a design phase, a designer identifies the best way to gather information per make and model of vehicle, per symptom and per problem to be diagnosed.

There may also be a local application (21) running on the onboard driver infotainment system, to process the machine learning model or make a decision to pass on the data detected by the devices, or processing those inputs and then send them to the cloud database.

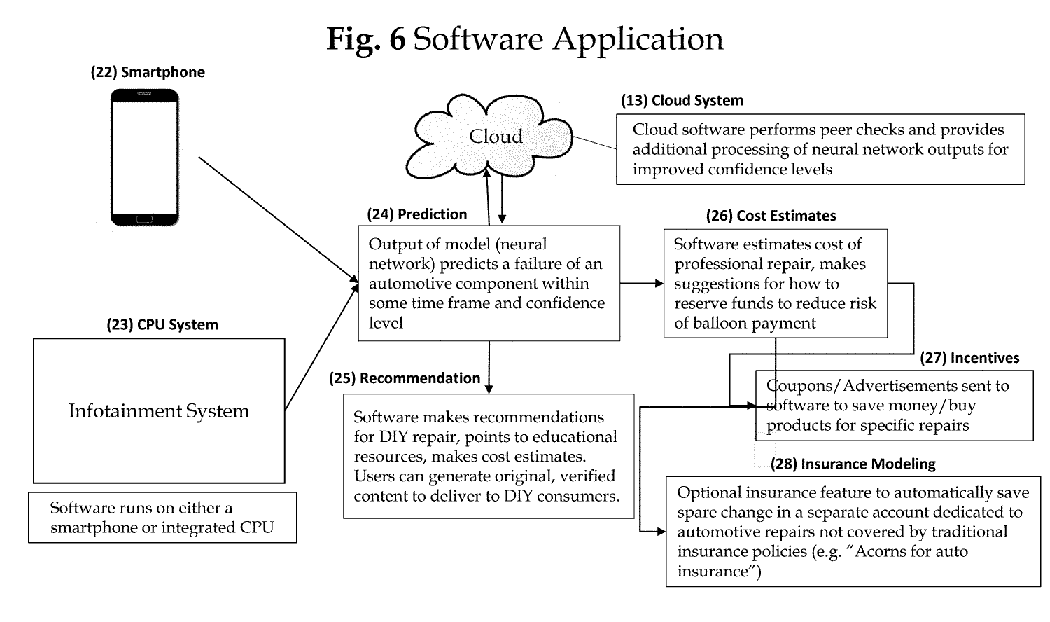

FIG. 6 illustrates performance of the software application, with more detail of smartphone (22) versus integrated software running on an onboard driver infotainment system (23). In a first example, the ML model predicts a failure of a component that has not yet happened (24), and it identifies that with some confidence level, and a likely time frame before failure is expected.

Next, the software, either running on the phone (22) or the integrated onboard system (23), or other on-board user notification system, will notify the user through some indication that an issue has been identified. The report may also use the output(s) of algorithm(s) that provide estimates (30)(26) based on average use of the vehicle and problems identified in the past from other similar vehicles with improved confidence level in the diagnostics.

In one example, the ML model may conclude that the detected symptom (such as a slight squeal in the brakes) is likely to become a problem in some future time (two weeks, two months, whatever), but the system can also make some estimation of when the user needs to address the issue (24). The system may also perform some calculations to estimate what it might cost a professional to address the issue (30)(26).

The system may or may not send out information to mechanics for quotes (even when it's not a problem yet). This can provide the consumer with information to make a better decision on how to plan for the eventual expense (30)(26). For example, the software may also make recommendations on how to budget for that expense, or connect to separate budgeting apps (27)(28).

The cost estimates can be simply extracted from a database of what it typically costs to replace the brakes on a 2012 Toyota Tacoma. However, this is also where other business methodologies may come into play, where the operators of the system could establish relationships with partner networks of mechanics to obtain more exact estimates (30)(26)(27). The system can “run the numbers” from within the service network, and through some average analysis, tell the consumer “on average, this is what this repair costs among mechanics in your area” or similar queries (30)(26).

The software might also make recommendations for how to perform the repair (25), especially if this is something that most people who are not “gear heads” would want to fix themselves. This can be by providing access to resources for how to fix this specific problem, such as web links to educational resources, YouTube videos, social network postings, or the like.

There is also an opportunity to house content within the app itself and incentivize a crowd-sourced marketplace to generate content for purchase regarding DIY repairs (25). The approach may be similar that of Udemy.com but with a focus on automotive DIY repair.

Another opportunity exists to verify or certify individuals who generate legitimate and valuable content (25). There can also be a feature similar to “Teledoc” where a mechanic is willing to teleconference with the user to help guide them through the repair in real-time. This could use technologies like video conferencing, augmented reality, or virtual reality to facilitate the walk through.

When sending out the diagnostic information to the network of mechanics nearby, the software application can highlight certain favorite mechanics of the user or recommend mechanics for a user who needs one, and/or mechanisms in the app may only show highly rated mechanics (27).

After being shown a list of available repair shops, the user may request further information about the actual costs, which can be collected by the software (through the database) (13) sending out an electronic notification to the partner mechanic networks, requesting them to bid on this work. That may consist of the mechanics receiving an email or some other notification, or clicking onto a Web based application and submitting their quote. This information, can then be collected and provided in detail in some human readable format for the user.

The request for quote may include the detailed sensor data (e.g. engine pinging with some frequency, or however much detailed information we can provide from our machine learning model so that the mechanic may made an accurate estimate).

In another arrangement, partner networks may opt for some automated response such that they can indicate an array of services they provide for fixed prices such as oil changes, replacing oxygen sensors, brake pads, etc (30)(26).

The system may also support other features that can help keep mechanics honest. For example, some mechanic might tell an unwitting consumer that the spark plugs need to be replaced. However, the methods and systems described herein now supply information to the consumer that in fact the spark plugs is not an issue based on previously collected information (either from the vehicle itself or from past experience with similar vehicles)

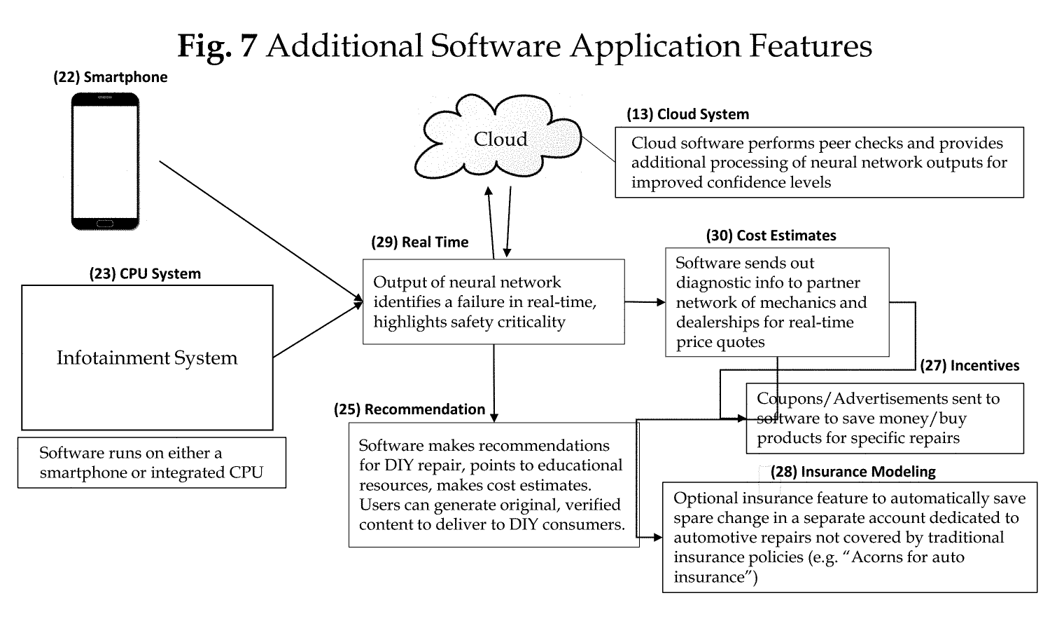

FIG. 7 illustrates the output of a machine learning model that identifies a failure in real-time, that is, something has happened (the engine is pinging, or the brakes are squealing), and there is some relative importance, or not, of the issue (29). In one example, perhaps an automatic moisture sensor for the windshield wipers has stopped working. This may typically be very low risk and most people would just ignore it in the short term. A failed brake line, however, may be flagged as critical and needing immediate attention. Thus the system can provide “hot”, “medium”, “cold” rating for the failure indicating whether it is something you need to pay attention to immediately, or to get to when you can.

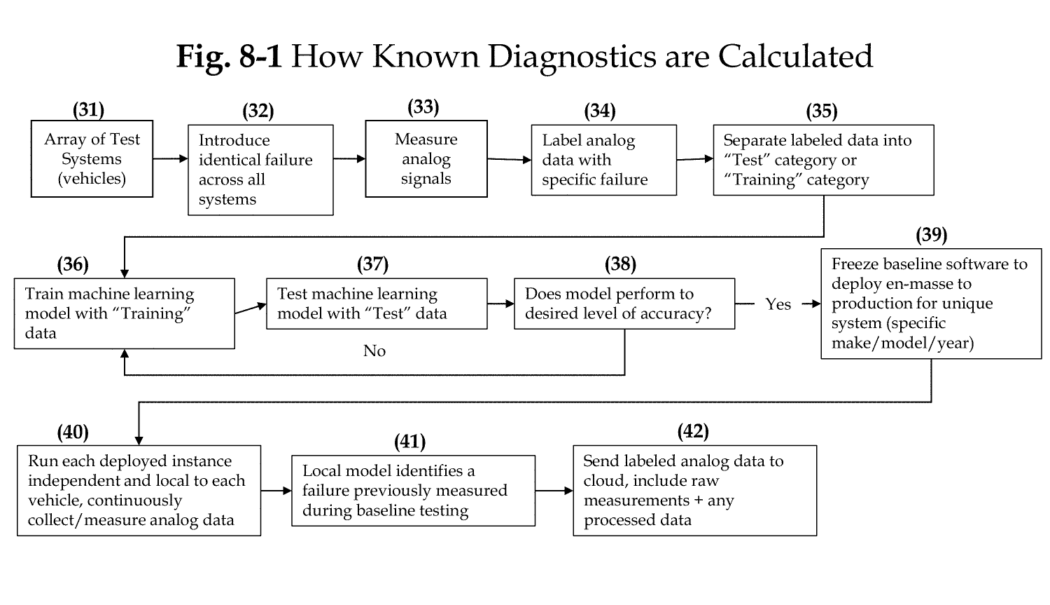

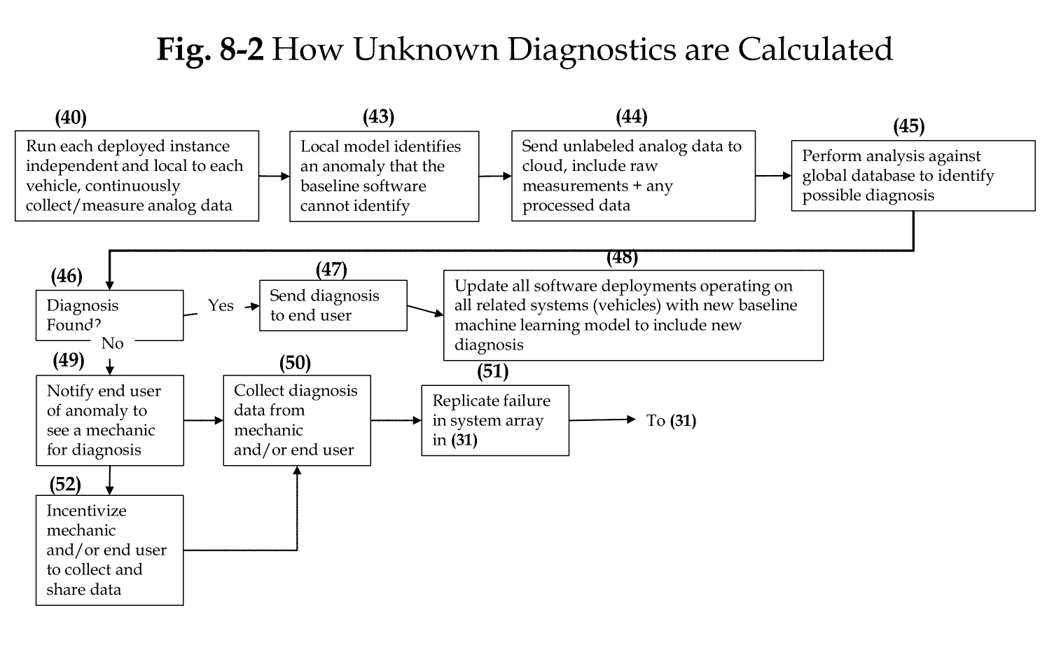

FIG. 8-1 and FIG. 8-2 shows some examples for how diagnostics may be calculated, typically in the design phase. This is where most of the investment in the system would need to be made upfront. It would help to partner with some manufacturer or OEM so that a significant sample set of cars of the same make, model, and year can be located for data gathering (31).

Once the sample size is selected (say one thousand 2010 Toyota Camrys), the system designer arranges to introduce the same specific failure across all cars or some sample size of the cars (32). All vehicles are then measured using analog systems to gather all raw, unprocessed data (33). This is the data that is used to build the machine learning models.

In one example, the system designer will introduce an engine pinging issue across all 1000 2010 Toyota Camrys (32) and record the raw audio and vibration signal across all of them (33), which will generate a set of outputs. Knowing that he introduced an engine pinging issue, and knowing that the sensor signatures collected are symptomatic of that engine pinging failure, then the designer can label the data outputs with the specific failure (34). The data will be separated into different sets. One set of data may be used to train the ML model while the other will be used to test the trained ML model (35).

As the machine learning model is first started, it may indicate a false output (it is not yet detecting anything different), in which case the system designer will reject that conclusion to the ML model. The machine learning model, using training data, or some other training mechanism, will process the conclusion, iterating until it gets to the correct answer with some confidence level.

Once the machine learning model has been trained to the desired confidence level, when that confidence level is reached, a baseline has been determined for that symptom (39). This machine learning model setting then becomes a baseline that is deployed in the field for diagnosing engine pinging in all 2010 Toyota Camrys (40).

As these get deployed in the field, other people driving 2010 Toyota Camrys will now be running this machine learning model, and may continue to be self training, self learning and adaptive (43). In the case that a vehicle running a locally deployed ML model cannot identify an anomaly not previously measured, the local system may send all measurement data specific to that anomaly to a cloud system (44). The cloud system may attempt to diagnose the anomaly by processing the data further and then analyze it against the global population of data from other deployments and test data (45). Once a diagnosis is found the result may be sent back to the end user, and the local system is updated with an improved ML model (48).

If the cloud system is unable to diagnose the failure across its global database, the end user may be asked to engage a mechanic or other manual process to diagnose the system (49). An optional incentive program may be developed to reward the end user and mechanic, or other manual process, to gather and share the diagnosis information which can be used to improve the ML model (52). The test data process may start again by introducing failures into the array of vehicles in order to generate enough resultant data that can then train and test the machine learning model (51).

So, let's say out of 100,000 2010 Toyota Camrys in the field, as their individual ML models continue to train themselves, the result could potentially be 100,000 unique instances of a machine learning model running on these different vehicles, although the starting baseline was the same. In other implementations, the 100,000 machine learning models in the field can be used to crowd source information to adjust themselves collectively.

In other words, crowd sourced data may also be used to train the machine learning model. This is another adaptation of the supervised learning model. Collecting acoustic information from mechanics and individuals will be used to strengthen or correct the machine learning model.

Thus, the machine learning model can be developed by sampling a population of known cars as an initial development exercise, which might make sense if you are Toyota Motor Corporation where access to 1000 Toyota Camrys is easy.

However, the machine learning model can also be trained by crowd sourcing data, by just gathering data as things happen in the field. The system will eventually obtain data from 100,000 Toyota Camry engine pinging issues that way as well.

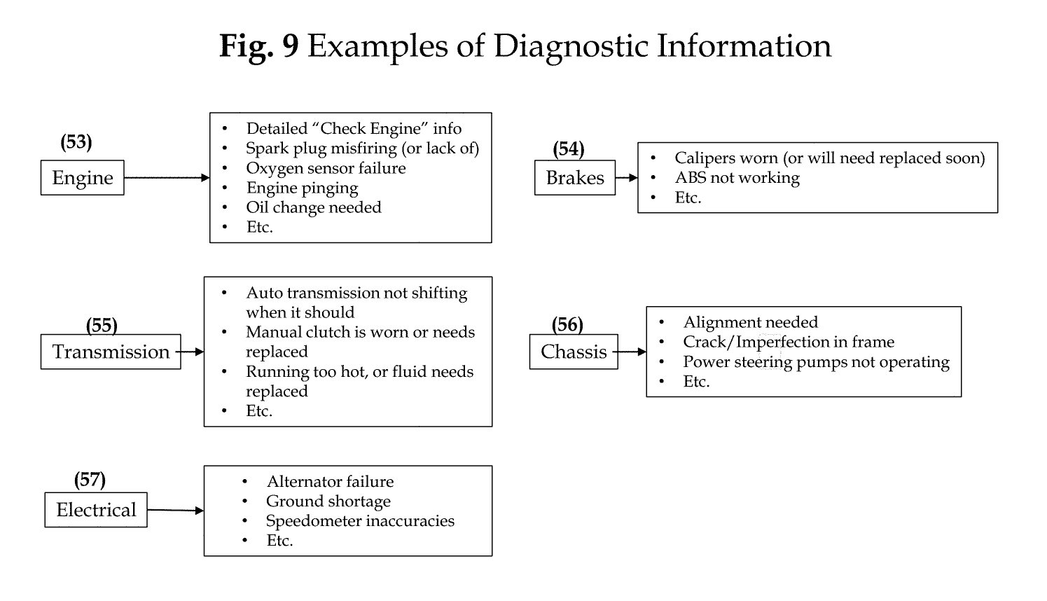

FIG. 9 shows examples of diagnostic information that might be collected from engine (53), transmission (55), brakes (54), electrical (57) or chassis (56) sensors that include mechanical components that are moving, that are generating vibrations, or that are generating unexpected sounds, etc. In other instances, the sensors may detect a disturbance or irregularity in some electromagnetic (EM) field. This might be caused by a warped brake rotor, failed alternator, failed ignition system, or some other failed electromagnetic component such as a failed Automatic Braking System (ABS).

These sensors may detect one type of EM field in normal operation, and then when the component starts to fail, it may generate a different EM field, which can be used to detect the symptom.

The system may operate differently for driverless vehicles than manned vehicles. This is because the ultimate consumer of the information may not necessarily be the person driving. This may also apply to something like an Uber, or other fleet vehicle, where the owner/operator in need of the diagnostics and getting information fed back to them is remote.

Thus, a fleet operator is another category of entity that is interested in the information produced by the system. They may have the characteristics of both the individual owner and the manufacturer, and thus interests that overlap with both classes of users.

Thus, the application that notifies the user may operate differently in the fleet case. There might be some enterprise software that has access to the machine learning model through a cloud system, so the ML model is no longer being processed in the car, but the car is merely sending information to some cloud server to perform the neural processing on an enterprise-wide basis.

In this scenario, an operations center may have a number of technicians in some centralized location, where this information is collected from all over the country, for all the self-driving Ubers throughout the United States on a constant basis. Such a system might be monitoring all 100,000 self-driving Toyota Camrys and generating reports about the 5 that just failed in Denver, Colo. and notifying the fleet operator of the plans to fix them.

In that case, the network communication may also be different. In the single user/owner case, the system is dependent upon a smartphone being in the car, and that smartphone may be used to communicate sensor data, filter outputs, or machine learning model conclusions over the consumer's existing data plan. However, in the fleet case, data may instead travel over another communication network, such as a satellite communication network, mesh network, or a dedicated spectrum offered by a cellular network. This may be the only choice in some remote areas (drilling sites or fracking sites).

In the case of a fleet of self-driving Uber vehicles, there most likely are already going to be wireless vehicle tracking connections hardwired to the car, and it may be possible to use those existing networks. This may require keeping security in mind, since often there must be isolation between monitoring networks and control networks. Thus, collected sensor/filtered/processed/neural network/machine learning data in some implementations, might travel over a network separate from some network that is performing a critical control function.

There are many advantages to the systems and methods described herein.

The technology avoids using “static” “OBD II” type sensors that are captive and removes the need for physical connections to the vehicle to diagnose problems. Having sensors with outputs connected to adaptable signal processing and machine learning models, allows the same sensor set to adapt to growing feature sets.

Audio/vibration/EM characterization enables moving away from the limits of sensors and fixed diagnostic schemes, to enable perpetual improvements in the quality of diagnostics.

Auto mechanic knowledge is often “tribal,” and the general population finds auto diagnosis complicated. They don't understand what's going wrong, and are beholden to a mechanic to solve their problem. The system described herein provides guidance and advice, as well as a reliable and trusted diagnosis of problems, to such consumers.

The system also provides value to mechanics and OEMs. One key value at the OEM level (and maybe at the maintenance level) is removing the need for point to point wiring at the time of manufacturing, reducing the cost to produce a vehicle.

It is also evident that the technology is applicable outside of automotive diagnosis, such as aerospace, or fracking, or pretty much anything that generates sensor signals to diagnose anomalies or faults.

In another application, the sensors may be able to pick up signals from outside the vehicle, from other cars on the road, or other nearby sounds. These sounds can be used to diagnose an event such as hitting a pothole and not only deciding that the front end may need to be checked for alignment, but also identifying the location of a pothole in the road and reporting it to road maintenance personnel.

The sensor information may also be used in a connected cities environment. The pothole followed by a large water splash may be indicative of a blocked drain. The sensors can also sense things in the world that have nothing to do with the car or the road condition, but can be fed back to some municipality who might be interested in what's “going on”. Perhaps a gunshot is heard, or maybe there is an accident nearby, and first responders need to know.

The technology is also intended to improve the following hurdles in diagnostics:
Send instant diagnostic data to mechanics and OEMs with specific problems
Gain instant understanding of problem
Quote more jobs in shorter time
Feed quote back to customer ASAP
Save room on auto body lots
Focus more on customer service
Reduce stress in customer relationship
Facilitate transition away from manual diagnostics to customer service specialist
Create loyalty and repeat customers
Incentivize and reward mechanics for creating positive customer experiences
Remove 100% of the guesswork for the consumer
Allow the consumer to think about the car less, focus more time on the experience at the destination
Remove responsibility from the vehicle owner, including owner(s) of autonomous and shared vehicles

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, and/or a combination of hardware and software.

Program code (sometimes referred to herein as code) is to be broadly interpreted to include text-based, or graphics-based, computer instructions that may be automatically executed, compiled and/or synthesized; binary code that may be executed (e.g., executable files that may directly be executed by an operating system, files that can be used to configure a field programmable gate array (FPGA), Java code, object files combined together with linking directives, source code, make files, or the like); text files executed in conjunction with other executables (e.g., Python text files, dynamic-link library (DLL) files with text-based combining, configuration information that connects pre-compiled modules, an extensible markup language (XML) file describing module linkage, or the like). In one example, code may include different combinations of the above-identified classes (e.g., text-based code, binary code, text files, or the like).

It will be apparent that systems and/or methods, described herein, may be implemented in different forms of hardware, firmware, or a combination of hardware and software. The actual specialized control hardware or software code used to implement these systems and/or methods is not limiting of the implementations. The programmable processors may be located in smartphones, or within vehicle computing systems, remote to the vehicle, other distributed processors, or provided in whole or in part by on-demand cloud-based processing.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. No element, act, or instruction used herein should be construed as critical or essential unless explicitly described as such.

What is claimed is:

1. An automotive diagnostics system comprising:
a first sensor interface, for receiving one or more outputs from an on-board vehicle diagnostic system;
a second sensor interface for receiving one or more auxiliary sensor outputs, at least one of which includes an audio or vibration sensor output; and
one or more processors, for executing program code to:
receive sensor data from the first and second interfaces; and
devise a supervised learning model to map both the on-board vehicle diagnostic system outputs and auxiliary sensor outputs to an automotive fault condition.

2. The system of claim 1 wherein the one or more processors further execute the program code to:
train the supervised learning model from the sensor data.

3. The system of claim 2 wherein the one or more processors further execute the program code to:
use the sensor data as other inputs to the supervised learning model.

4. The system of claim 1 wherein the second interface couples to at least one of (a) a smartphone associated with an operator of the vehicle or (b) a dedicated sensor device.

5. The system of claim 1 wherein a first one of the processors is a smartphone associated with an operator of the vehicle, and a second one of the processors is remote from the vehicle and the smartphone.

6. The system of claim 1 wherein the one or more processors further execute the program code to:
develop a supervised learning model that relates to the specific individual vehicle to which the on-board diagnostics is physically connected.

7. The system of claim 1 wherein the one or more processors further execute the program code to:
forward the on-board diagnostics and auxiliary sensor outputs as crowd-sourced data to a supervised learning model relevant to a vehicle make, model and year of manufacture.

8. The system of claim 7 wherein the supervised learning model is specific to a particular fault.

9. The system of claim 1 where wherein the one or more processors further execute the program code to:
forward the on-board diagnostics and auxiliary sensor outputs to a one or more processors associated with a vehicle manufacturer, vehicle dealer, or repair facility.

10. The system of claim 1 wherein the one or more processors further execute the program code to:
report that a fault has a occurred to the vehicle operator.

11. The system of claim 10 wherein the report further includes an estimate of a cost to address the fault.

12. The system of claim 1 where the wherein the one or more processors further execute the program code to:
predictive analytics for early diagnosis of an upcoming repair with (a) a budget estimate and (b) a time by which the detected automotive fault condition is to be repaired.

13. A method comprising:
obtaining one or more diagnostic codes from an on-board diagnostic system within a vehicle;
obtaining one or more sensor signals from audio, vibration and/or other sensors associated with the vehicle;
applying one or more filtering or signal processing operations to the sensor signals;
feeding outputs of the one or more filtering or signal processing operations and the sensor signals to a supervised learning model to determine diagnostic information;
forwarding parameters of the supervised learning model collected on a per vehicle basis to a crowd sourced database; and
providing access to the crowd-sourced databased to applications associated with one or more of consumers, fleet operators, vehicle manufacturers, vehicle dealers, other equipment manufacturers, or repair facilities.
